(19) United States
(12) Patent Application Publication
(10) Pub. No.: US 2011/0183707 A1
(43) Pub. Date: Jul. 28, 2011

(54) Device and method for frequency conversion

(76) Inventor: Volker Hoehn, Krefeld (DE)

(21) Appl. No.: 12/931,269

(22) Filed: Jan. 26, 2011

(30) Foreign Application Priority Data
Jan. 26, 2010 (DE) 10 2010 000 193.7

(51) Int. Cl. H04W 88/16

(52) U.S. Cl. 455/552.1; 455/550.1

(57) ABSTRACT

The invention relates to a device and a method for frequency conversion of radio signals between a mobile terminal and a base station in a telecommunications network. The device comprises at least one transmitting device and receiving device for transmitting and/or receiving radio signals in different frequency bands, and at least one conversion unit for converting the radio signals from a first frequency band into a second frequency band. The device and the method enable a mobile terminal to communicate in a telecommunications network, even though the provided operating frequencies of the terminal differ from the frequencies with which the base station of the telecommunications network is operated.

### FIELD OF THE INVENTION

The invention relates in general to frequency conversion of radio signal between a mobile terminal and a base station in a telecommunications network. More specifically, the invention relates to device and method for frequency conversion of radio signals between a mobile terminal and a base station in a telecommunications network.

### BACKGROUND OF THE INVENTION

In view of the requirements of regulatory authorities in different regions of the world, telecommunications networks in the field of UMTS (UMTS: Universal Mobile Telecommunication System) and the future LTE (Long Term Evolution) are operating at different frequency bands.

In order to improve the area-wide radio network supply telecommunications networks are operating in different frequency bands, e.g. as UMTS 900 in the 900 MHz range, or as UMTS 850 in 850 MHz range.

EP 0418096 discloses a telecommunications network which is divided into several cells. To each of these cells a repeater is allocated for the conversion of radio signals between a mobile terminal and a base station in a telecommunications network, wherein said repeater comprises at least one transmitting and one receiving device for transmitting or receiving radio signals. The repeater shall receive, convert and amplify the radio signals transmitted from a mobile terminal, and reversely receive, convert and damp the radio signals transmitted from the base station of a telecommunications network to a terminal.

A disadvantage of this prior art is that the repeater can transfer radio signals between the mobile terminal and the base station only in the same frequency band.

### SUMMARY OF THE INVENTION

As to one aspect of the invention, a device is provided comprising at least one transmitting and receiving device for transmitting or receiving radio signals in different frequency bands. As to another aspect of the invention, a method is disclosed for frequency conversion of radio signals between a mobile terminal, a frequency converter and a base station in a telecommunications network.

As to a further aspect of the invention, a mobile terminal is able to communicate in telecommunications networks using different frequency bands.

A device for frequency conversion of radio signals between a mobile terminal and a base station in a telecommunications network is provided. This device comprises at least one transmitting and receiving device for sending or receiving radio signals in different frequency bands, and wherein said device comprises at least one conversion unit for converting said radio signals from a first frequency band to a second frequency band.

A method for frequency conversion of radio signals between a mobile terminal, a frequency converter, and a base station in a telecommunications network is also disclosed. This method comprises the following steps: receiving radio signals from the mobile terminal or the base station in a first frequency band by the frequency converter; converting the radio signals of the first frequency band into radio signals of a second frequency band by the frequency converter; and sending the radio signals converted into the second frequency band from the frequency converter to the base station or to said mobile terminal.

### BRIEF DESCRIPTION OF THE DRAWINGS

Exemplary embodiments of the invention will be now described in greater detail herein below with reference to the accompanying drawings, in which:

FIG. 1 is a schematic diagram of a telecommunications network with a base station, a mobile terminal, and a device for frequency conversion; and

FIG. 2 is a schematic diagram of a telecommunications network during a handover with base stations, mobile devices and devices for frequency conversion.

### DETAILED DESCRIPTION OF THE INVENTION

In a preferred embodiment of the invention, a detection unit for detecting the transmitting and receiving power and/or the received signal quality of the radio signal is provided.

The detection unit may for example have the following effects: it ensures the best receiving signal for a mobile terminal and, during a handover of a mobile terminal in a telecommunications network, supports the transfer of the communication of the mobile terminal to another device according to the invention and hence ensures an uninterrupted communication.

In a preferred modification of the invention the transmitting and receiving device comprises an arrangement for receiving and/or transmitting the radio signals according to different UMTS transmission methods.

A beneficial effect is that according to the invention the device being a technically autonomous device or collocated with the base station or another entity of the UMTS telecommunications network can be used in all UMTS telecommunication networks, which, for example, transmit the radio signals according to the FDMA technique (FDMA=Frequency Division Multiple Access) and/or the CDMA technique (CDMA=Code Division Multiple Access) and/or OFDMA technique (OFDMA=Orthogonal Frequency Division Multiple Access) and/or FDD technique (FDD=Frequency Division Duplex), in order to enable communication to the mobile terminal.

In one modification of the invention a conversion unit is preferred, which comprises an arrangement for converting radio signals from a UMTS core frequency band (3G core band) into a frequency band of the telecommunications different to the UMTS core band.

Such a conversion unit allows converting the radio signals sent and received in the UMTS core band between the mobile terminal and the base station in a way that the mobile terminal can communicate in the UMTS telecommunications network, which is operated in the frequency band different to the UMTS core band.

In one possible modification of the invention, the telecommunications network is a telecommunications network according to LTE standard.

For this reason, there is provided a stand-alone technical device or a device collocated with the base station or other devices of the UMTS telecommunications network, the device provides an effective use of high-rate data services and transmission of voice services and video telephony via the Internet Protocol Voice over IP (VoIP) for mobile terminals in networks of this standard compared to mobile terminals in UMTS telecommunications networks.

In one embodiment of the invention the transmitting and receiving device in the telecommunications network according to LTE standard comprises means for receiving and sending radio signals considering a bandwidth in a first or second frequency band.

This enables the transmitting and receiving device to transmit the received and transmitted radio signals using the correct bandwidth, the latter dimensioned by the network planning of the telecommunications network, and thus an undisturbed communication of the terminal with the base station is assured.

In one modification of the device of the invention in the telecommunications network according to LTE standard the conversion unit comprises an arrangement for converting the radio signals determining the bandwidth of the radio signal in the first or second frequency band.

This now enables the conversion unit to consider the required band width according to LTE standard in the frequency conversion of received and transmitted radio signals and guarantees an uninterrupted communication between the mobile terminal and the base station.

In one embodiment of the method of the invention for frequency conversion of radio signals between the mobile terminal, the frequency converter and the base station in the telecommunications network, the method is enhanced by the steps of receiving the radio signals of the mobile terminal in the first frequency band in the frequency converter; converting the radio signals of the first frequency band into radio signals of the second frequency bands in the frequency converter; and sending the radio signals converted into the second frequency band from the frequency converter to the base station.

In doing so an undisrupted communication in the uplink path of the mobile terminal via the inventive device to the base station is provided.

In another embodiment of the method of the invention for frequency conversion of radio signals between the mobile terminal, the frequency converter and the base station in the telecommunications network, the method comprises the steps of receiving the radio signals of the base station in the first frequency band in the frequency converter; converting the radio signals of the first frequency band into radio signals of the second frequency band in the frequency converter; and sending the radio signals converted into the second frequency band from the frequency converter to the mobile terminal.

Thus, interference-free communication in the downlink path of the mobile terminal from the base station over the device is provided.

In a further modification of the method of the invention the received radio signals are converted from a UMTS core frequency band (3G core band) into a frequency band of the telecommunications network different to the UMTS core band.

Such a method allows converting the radio signals sent and received in the UMTS core band between the mobile terminal and the base station in a way that the mobile terminal can communicate in a UMTS telecommunications network, which is operated in frequency band different to the UMTS core band.

In a preferred embodiment of the method, the bandwidth of the received radio signal in the first or second frequency band in the telecommunications network according to LTE standard is determined for considering the detected bandwidth when converting the radio signal.

Such a method permits considering the proper bandwidth during frequency conversion of received and transmitted radio signals, and guarantees an uninterrupted communication between the mobile terminal and the base station.

A further modification of the method of the invention enables a user to transmit and receive the radio signals of the mobile terminal at the start, end, and during communication via one of the different advantageous embodiments of the device according to the invention in the telecommunications network.

This ensures that the mobile device can perform an uninterrupted communication between the base station and the mobile terminal from the beginning to the end of the inventive method.

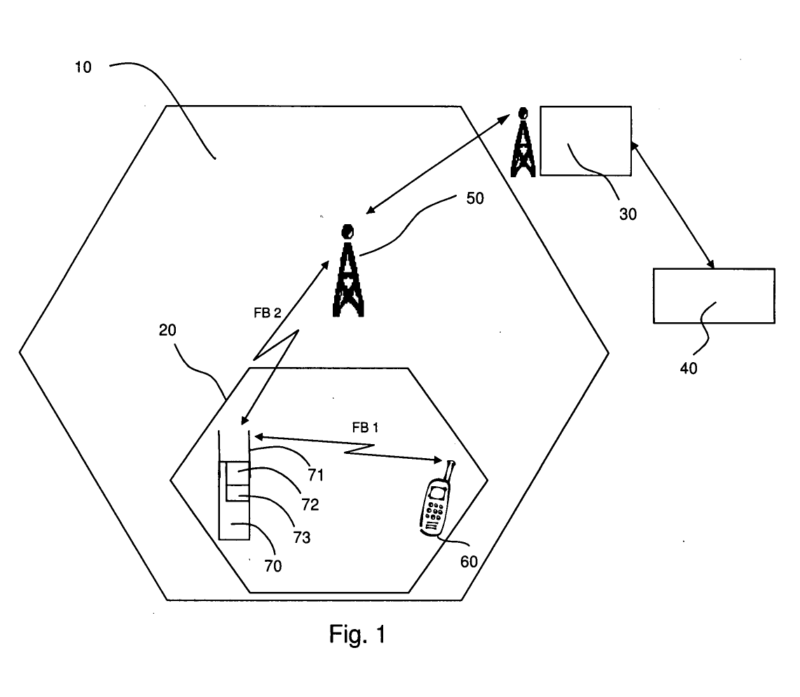

Referring now to the drawings in general and FIG. 1 in particular, where the numeral 10 designates a radio cell in a schematic section of a telecommunications network. The radio cell comprises a sub cell 20. The radio cell 10 with the sub cell 20 is part of a telecommunications network of the 3rd or 4th Generation, for example according to the UMTS or LTE standard. In addition the telecommunications network comprises further network elements for processing and transmission of radio signals to other mobile terminals or other devices, such as a base station controller (BSC) in a telecommunications network according to GSM standard or a radio network controller 30 (RNC) in a telecommunications network according to the UMTS standard, and amongst others a mobile switching center 40 (MSC). The corresponding network elements of such telecommunications networks are known in the art and are represented stylized for simplicity.

The radio cell 10 comprises a base station 50 for transmitting and receiving radio signals. Furthermore, an exemplary mobile terminal 60 is shown in FIG. 1. The mobile device 60 may for example be a cell phone, car phone, Smartphone or mobile computers (PDA, notebook) or another device that can communicate with a telecommunications network.

The sub cell 20 includes an inventive device for frequency conversion 70. The device for frequency conversion 70, hereinafter in short referred to as frequency converter 70, comprises a transmitting and receiving device 71, a conversion unit 72 and a detection unit 73. The frequency converter 70 is shown in this preferred exemplary embodiment as technically autonomous device, but can also be applied collocated with the base station 50 or other means of telecommunication network.

The transmitting and receiving device 71 consists of one transmitting and one or two receiving antennas, wherein, for example, 3-in-1 antenna systems also structurally integrate the transmitting and receiving antenna(s) into an antenna.

Typically for UMTS telecommunication networks the detection unit 73 comprises a so-called rake receiver. This rake receiver reduces the adverse effect of multipath propagation of the received radio signals by combining the radio signal energy from all received multipath components.

A rake receiver comprises a plurality of so-called rake fingers, wherein in an ideal case one rake finger is assigned to one transmission path and thus one received signal version respectively. In each rake finger, the received signal is despread using the spreading code. The despread signals from the individual rake fingers are then weighted and superimposed in a so-called maximum ratio combiner (MRC) in the symbol rate according to the attenuation of the transmission path.

In particular, the frequency converter 70 in a sub cell 20 enables a use of the mobile terminal 60 in the telecommunications network. For that purpose the mobile terminal 60 communicates via the frequency converter 70 to the base station 50 and further over the radio network controller 39 and the mobile switching center 40 of the telecommunications network to the terminal of the other subscriber 80.

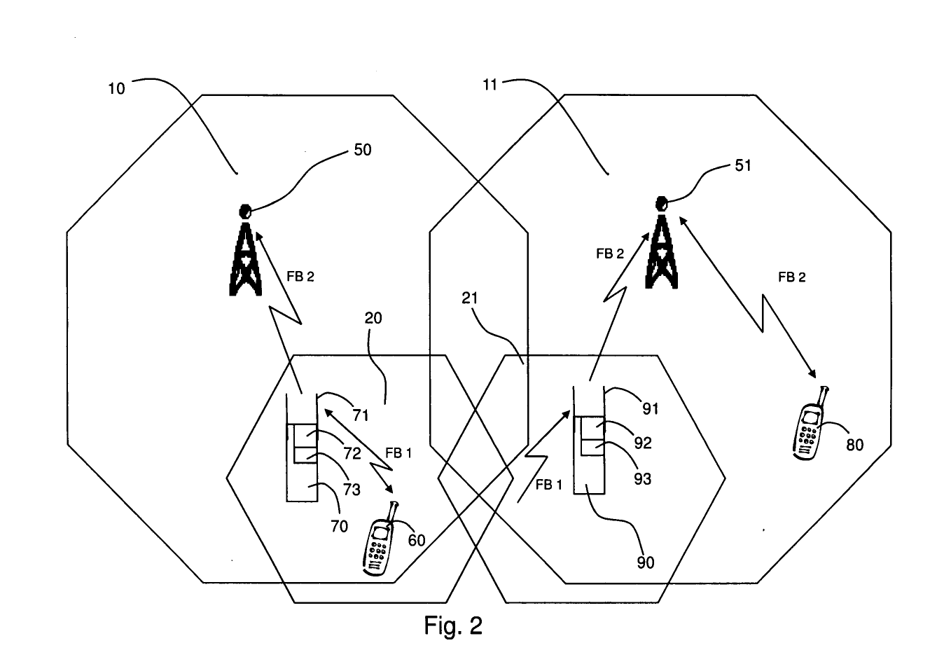

In the following the method for frequency conversion of radio signals is described for a UMTS telecommunications network, as shown in FIG. 2.

In this exemplary embodiment, the telecommunications network is operated in the frequency band UMTS900 (FB 2). The mobile terminal transmits and receives signals in the core band UMTS2100 (FB 1).

The frequency converter 70 receives radio signals from the mobile terminal 60 in the core band (FB 1) via the transmitting and receiving device 71. The conversion unit 72 in the frequency converter 70 converts the radio signals received in the core band UMTS2100 (FB 1) into radio signals in the frequency band UMTS900 of the telecommunications network (FB 2), via which the mobile terminal desires to communicate. The radio signals converted into the frequency band UMTS900 are sent to the base station 50 via the transmitting and receiving device 71 of the frequency converter 70. These radio signals are then transmitted from the base station 50 to the radio network controller 30 and via radio links or fixed lines to the mobile switching center 40. From the mobile switching center 40, the radio signals are transmitted depending on the location of the terminal of the other subscriber. For example, they are transmitted into the fixed network of the selected land line connection or, if the other subscriber is residing with his terminal in the telecommunications network, the mobile switching center 40 forwards the radio signals via said radio network controller or another radio network controller to a base station and from there to the terminal 80 of the other subscriber.

The base station 50 processes the received signals (FB 2) of the frequency converter 70 according to the known CDMA method and transmits radio signals in the UMTS900 band (FB 1) via radio network controller 30, for example to the other mobile terminal 80.

The frequency converter 70 receives radio signals (FB 2) from the base station 50 via the transmitting and receiving device 71 and converts them into radio signals of the core frequency bands UMTS2100 (FB 1) in the conversion unit 72. The converted radio signals (FB 1) are sent to the mobile terminal 60 over the transmitting and receiving device 71 of the frequency converter 70. During transmission and reception of radio signals between the mobile terminal 60 and the base station 50 in a telecommunications network, the frequency converter 70 transfers all parameters of the UMTS telecommunications network to the mobile terminal 60.

In the event that the mobile terminal 60 leaves the area of sub cell 20 and there is no other sub cell with a frequency converter outside of sub cell 20, the communication between the mobile terminal 60, the frequency converter 70 and thus also the base station 50 is terminated because the mobile terminal 60 transmitting and receiving in the core band UMTS2100 (FB 1) cannot communicate in the telecommunications network directly via the base station 50, which sends and receives in the UMTS900 frequency band.

In the case shown in FIG. 2, in which the mobile terminal 60 moves from the area of sub cell 20 in the area of sub cell 21 and thus a change of the radio cell 10 to a radio cell 11 also takes place, this change is carried out by soft handover or hard handover or HSDPA Cell Change. HSDPA stands for High Speed Data Packet Access.

A handover is defined as an operation in a telecommunications network in which the mobile terminal 60 changes from one radio cell to another during a call or data connection. During the handover another cell takes in control of the connection. Also known are intra-cell handovers, i.e. the frequency change in the event that the previously-used frequency is no longer available. Handovers are initiated on the network side and are divided into hard handover and soft handover.

During a hard handover the connection is passed to another cell within a very short period of time. This type of handover is used in GSM telecommunications networks because GSM telecommunications networks only provide technical support for this type of handover. So-called soft handovers are used in UMTS telecommunication networks. During a soft handover, the mobile terminal 60 can be connected to a maximum of three base stations, or in our example to two frequency converters 70, 90. This is referred to as so-called macro diversity. The connection handover during changing from sub cell 20 to sub cell 21 is not suddenly but “soft”. The coordination of this handover and the combining of the received signals are made by the next higher network element in the radio network hierarchy, in our example in FIG. 2 by the radio network controller 30, since the soft handover is carried out between the sub cells of two different base stations 50, 51.

During the handover between two sub cells in a radio cell the base station 50, in our example the Node B of a UMTS telecommunications network would directly control the combining. In this case, is a person skilled in the art speaks of a “softer handover”.

Depending on the involved technical elements of the telecommunications network, a handover can be differentiated by a person skilled in the art, for example into Intra-BTS handover, Inter-BSC handover, Intra-RNC handover or Inter-MSC handover.

If the mobile terminal 60 being an UMTS2100 mobile terminal in connection with the frequency converter 70 of the sub cell 20 moves into the sub cell 21, the mobile terminal 60 and the frequency converter 70 both process the received radio signals from the other terminal 80 or the adjacent frequency converter 90 as radio signals, which can occur from so-called multipath propagation in the radio cells 10, 11 or the sub cell 21. The detection unit 73 in the frequency converter 70, in this example the so-called rake receiver has the function to combine and process the different received radio signals and to support the handover. Same type rake receivers are also provided in the mobile terminals 60, 80 to conduct the same operations as described above for a terminal.

The size, shape, design, material selection and technical conception of the forgoing and claimed components described in the exemplary embodiments and to be used according to the invention are not subject to any particular exceptional conditions so that the well-known selection criteria in the field of application can be applied without restriction.

What is claimed is:

1. A device for frequency conversion of radio signals between a mobile terminal and a base station in a telecommunications network, said device comprising:
at least one transmitting and receiving device for sending or receiving radio signals in different frequency bands, wherein said device comprises at least one conversion unit for converting said radio signals from a first frequency band to a second frequency band.

2. A device according to claim 1, further comprising a detection unit for detecting the transmitting and the receiving power or the received signal quality of said radio signal.

3. A device according to claim 1, wherein said transmitting and receiving device comprises means for receiving or transmitting said radio signals according to different UMTS transmission methods.

4. A device according to claim 3, wherein said conversion unit comprises means for converting said radio signals from a UMTS core frequency band into a frequency band of said telecommunications network different to said UMTS core frequency band.

5. A device according to claim 1, further comprising a detection unit for detecting the transmitting and the receiving power or the received signal quality of said radio signal, wherein said transmitting and receiving device comprises means for receiving or transmitting said radio signals according to different UMTS transmission methods, and wherein said conversion unit comprises means for converting said radio signals from a UMTS core frequency band into a frequency band of said telecommunications network different to said UMTS core frequency band.

6. A device according to claim 1, wherein said telecommunications network is a telecommunications network according to LTE standard.

7. A device according to claim 6, wherein said transmitting and receiving device comprises means for receiving and sending said radio signals considering a bandwidth in said first or second frequency band.

8. A device according to claim 6, wherein said conversion unit comprises means for converting said radio signals determining a bandwidth of said radio signal in said first or second frequency band.

9. A device according to claim 1, wherein said telecommunications network is a telecommunications network according to LTE standard, wherein said transmitting and receiving device comprises means for receiving and sending said radio signals considering a bandwidth in said first or second frequency band, and wherein said conversion unit comprises means for converting said radio signals determining a bandwidth of said radio signals in said first or second frequency band.

10. A method for frequency conversion of radio signals between a mobile terminal, a frequency converter, and a base station in a telecommunications network, said method comprising the steps of:
receiving radio signals from said mobile terminal or said base station in a first frequency band by said frequency converter;
converting said radio signals of said first frequency band into radio signals of a second frequency band by said frequency converter; and
sending said radio signals converted into said second frequency band from said frequency converter to said base station or to said mobile terminal.

11. A method according to claim 10, further comprising the following steps:
receiving said radio signals of said mobile terminal in said first frequency band by said frequency converter;
converting said radio signals of said first frequency band into radio signals of said second frequency band by said frequency converter; and
sending said radio signals converted into said second frequency band from said frequency converter to said base station.

12. A method according to claim 10, further comprising the following steps:
receiving said radio signals of said base station in said first frequency band by said frequency converter;
converting said radio signals of said first frequency band into radio signals of said second frequency band by said frequency converter; and
sending said radio signals converted into said second frequency band from said frequency converter to said mobile terminal.

13. A method according to claim 10, further comprising the step of converting said received radio signals from a UMTS core frequency band into a frequency band of said telecommunications network different to said UMTS core frequency band.

14. A method according to claim 10, further comprising the step of determining the bandwidth of said received radio signals in said first or second frequency band in said telecommunications network according to LTE standard for considering said determined bandwidth when converting said radio signal.

15. A method according to claim 10, further comprising transmitting and receiving said radio signals of said mobile terminal at the start, and during communication via a device for frequency conversion of radio signals between said mobile terminal and said base station in said telecommunications network, said device comprising at least one transmitting and receiving device for sending or receiving said radio signals in different frequency bands, and wherein said device comprises at least one conversion unit for converting said radio signals from said first frequency band to said second frequency band.
